(19) United States
(12) Patent Application Publication
(10) Pub. No.: US 2012/0011171 A1
(43) Pub. Date: Jan. 12, 2012

(54) NODE DETERMINATION APPARATUS AND NODE DETERMINATION METHOD

(75) Inventor: Yuichi TSUCHIMOTO, Kawasaki (JP)

(73) Assignee: FUJITSU LIMITED, Kawasaki-shi (JP)

(21) Appl. No.: 13/157,799

(22) Filed: Jun. 10, 2011

(30) Foreign Application Priority Data
Jul. 6, 2010 (JP) 2010-154332

(51) Int. Cl. G06F 17/30

(52) U.S. Cl. 707/812; 707/E17.044

(57) ABSTRACT

A node determination method includes: associating a function with each of a plurality of nodes; calculating, by inputting a key for identifying specific data to each of the functions, a function value of the each of the functions; determining, on the basis of magnitude relation of the calculated function values, nodes for storing the specific data; and outputting a result of the determination.

### CROSS-REFERENCE TO RELATED APPLICATION

This application is based upon and claims the benefit of priority of the prior Japanese Patent Application No. 2010-154332, filed on Jul. 6, 2010, the entire contents of which are incorporated herein by reference.

### FIELD

The embodiments discussed herein are related to a node determination method for determining a node for storing data.

### BACKGROUND

Some kinds of distributed data store may have different nodes for storing data identified with each key for data. Some distributed data stores may store data corresponding to an identical key to a plurality of nodes redundantly from a viewpoint of fault tolerance. Some distributed data stores may dynamically increase or decrease the number of nodes without stopping the service of the data store.

For each key for data, such a distributed data store determines a node for storing data identified with a key from a plurality of nodes (what is called a key space division problem). According to a conventional method, one hash function h( ) is determined and then a node for storing data is determined on the basis of the remainder of the division of a hash value h(k), which is acquired by inputting a key k for the data to the hash function h( ) by the number of the nodes, for example.

In some data retention apparatuses, a node holding divided data acquires and distributes divided data held by another node without having management information such as location information of the divided data, for example.

Japanese Laid-open Patent Publication No. 2007-73003 discloses a related technique.

### SUMMARY

According to an aspect of the present invention, provided is a non-transitory computer-readable medium storing a node determination program causing a computer to execute a node determination method. The node determination method includes: associating a function with each of a plurality of nodes; calculating, by inputting a key for identifying specific data to each of the functions, a function value of the each of the functions; determining, on the basis of magnitude relation of the calculated function values, nodes for storing the specific data; and outputting a result of the determination.

The object and advantages of the invention will be realized and attained by means of the elements and combinations particularly pointed out in the claims. It is to be understood that both the foregoing general discussion and the following detailed discussion are exemplary and explanatory and are not restrictive of the invention, as claimed.

### BRIEF DESCRIPTION OF DRAWINGS

FIG. 1 is a diagram illustrating an example of a node determination process performed by a node determination apparatus according to an embodiment of the present invention;

FIG. 2 is a diagram illustrating an example of data relocation when a node is added according to an embodiment of the present invention;

FIG. 3 is a diagram illustrating an example of data relocation when a node is deleted according to an embodiment of the present invention;

FIG. 4 is a diagram illustrating an example of a distributed system according to an embodiment of the present invention;

FIG. 5 is a diagram illustrating an exemplary hardware configuration of a computer;

FIG. 6 is a diagram illustrating an exemplary functional configuration of a node determination apparatus according to an embodiment of the present invention;

FIG. 7 is a diagram illustrating an exemplary data structure of a key list according to an embodiment of the present invention;

FIG. 8 is a diagram illustrating an exemplary data structure of a function list according to an embodiment of the present invention;

FIG. 9 is a diagram illustrating an exemplary data structure of a function value list according to an embodiment of the present invention;

FIG. 10 is a diagram illustrating an exemplary data structure of a node/key correspondence list according to an embodiment of the present invention;

FIG. 11 is a diagram illustrating an exemplary operation flow of node determination management performed by a node determination apparatus according to an embodiment of the present invention;

FIG. 12 is a diagram illustrating an exemplary operation flow of a node determination process performed by a node determination apparatus according to an embodiment of the present invention;

FIG. 13 is a diagram illustrating an exemplary operation flow of node determination management performed when a node is added by a node determination apparatus according to an embodiment of the present invention;

FIG. 14 is a diagram illustrating an exemplary operation flow of node determination management performed when a node is deleted by a node determination apparatus according to an embodiment of the present invention;

FIG. 15 is a diagram illustrating a concrete example of stored information in a node/key correspondence list according to an embodiment of the present invention; and

FIG. 16 is a diagram illustrating a concrete example of stored information in a node/key correspondence list according to an embodiment of the present invention.

### DESCRIPTION OF EMBODIMENTS

In conventional techniques, when the number of nodes within a distributed data store increases or decreases, nodes for storing data may be drastically changed, causing a problem of the increase in data relocation between nodes. For example, according to the above-mentioned method, when the number of nodes within a distributed data store increases from ten to eleven, the nodes for storing data may be changed for ten-eleventh of the data.

It is preferable to provide a node determination method which may reduce data relocation between nodes when the number of nodes increases or decreases.

The embodiments may provide a node determination method which may reduce data relocation between nodes when the number of nodes increases or decreases.

With reference to attached drawings, the embodiments of a node determination method will be discussed below in detail.

Example of Node Determination Process

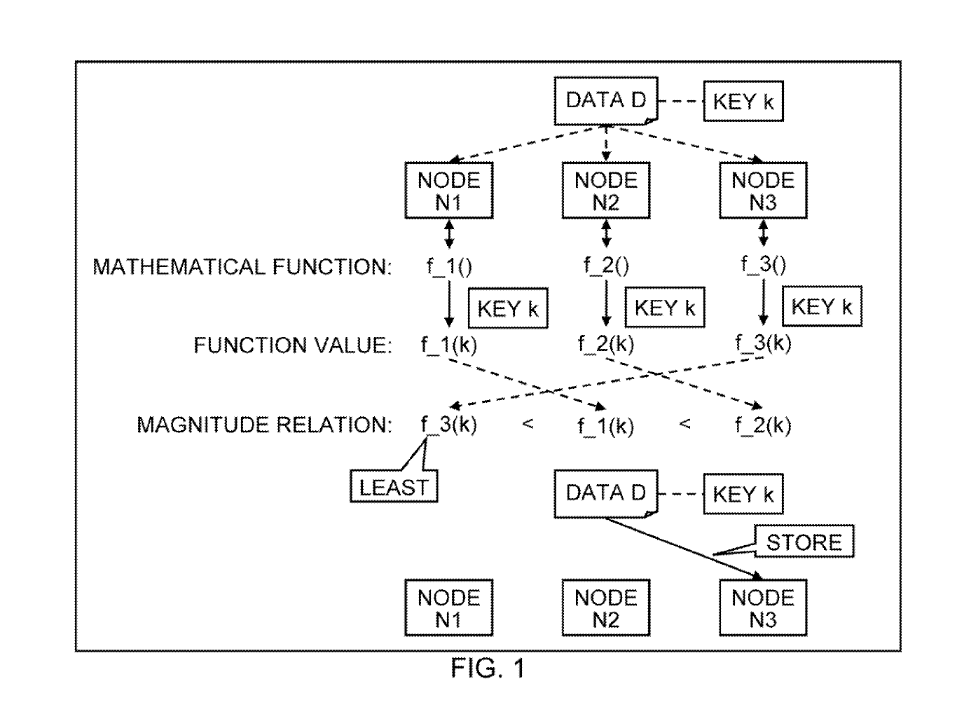

FIG. 1 illustrates an example of a node determination process performed by a node determination apparatus according to an embodiment of the present invention. In the present embodiment, it is supposed that a node N for storing data D is determined among nodes N1 to N3 within a distributed data store, for example.

A distributed data store is a system which stores a data group in a plurality of nodes (nodes N1 to N3, here). In the distributed data store, data D and a key k are paired. The data D may be referred by designating the key k. The key k for data D is information for uniquely identifying the data D.

Referring to FIG. 1, a node determination apparatus associates the node N1 with a function f_1( ) The node determination apparatus associates the node N2 with a function f_2( ) The node determination apparatus associates the node N3 with a function f_3( ) The functions f_1( ) f_2( ) and f_3( ) are different functions. The domain of each of the functions contains a key k for the data D. The ranges of the functions define magnitude relation among the values (referred to as function values) of the functions.

Next, the node determination apparatus inputs the key k for the data D to the functions f_1( ) f_2( ) and f_3( ) of the respective nodes N1 to N3 to calculate the function values f_1(k), f_2(k), and f_3(k) for the respective nodes N1 to N3.

The node determination apparatus determines the node N for storing the data D on the basis of the magnitude relation among the function values f_1(k), f_2(k), and f_3(k) for the respective nodes N1 to N3. For example, the node determination apparatus may determine the node N3 corresponding to the least function value f_3(k) among the function values f_1(k), f_2(k), and f_3(k) as the node N for storing the data D.

The present embodiment allows reduction of data relocation between nodes when the number of nodes within a distributed data store increases or decreases. Specifically, even when the number of nodes within a distributed data store changes, the magnitude relation among function values for the nodes N1 to N3 does not change, allowing suppression of the occurrence of data relocation between nodes.

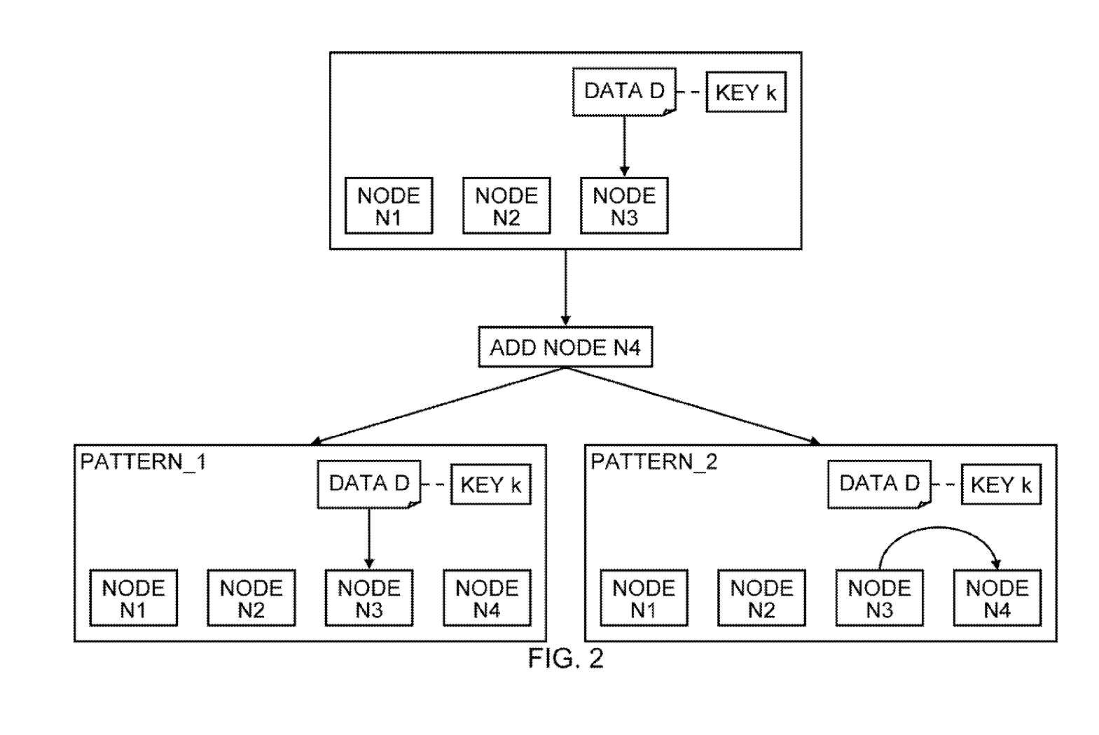

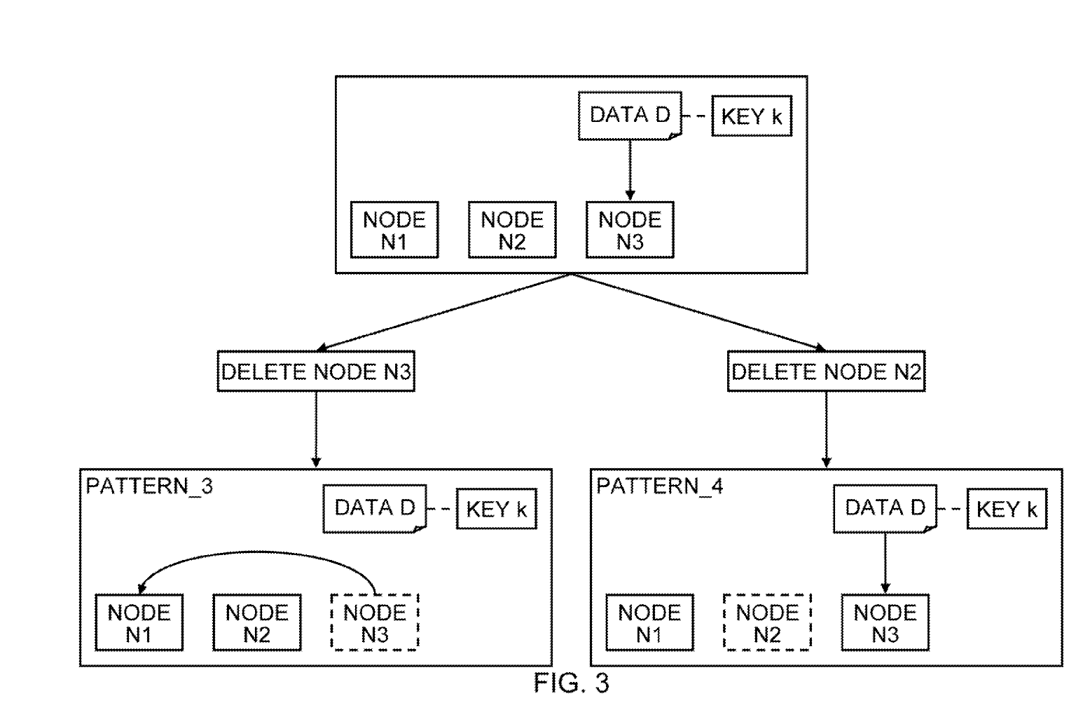

More specifically, for example, when the number of nodes within the distributed data store increases, data D is not relocated unless the function value for the node N to be newly added is the least. On the other hand, when the number of nodes within a distributed data store decreases, the data D is not relocated unless the node N3 is deleted. The data relocation between nodes when the number of nodes increases or decreases will be discussed below with reference to FIG. 2 and FIG. 3.

Example of Data Relocation When Node is Added

FIG. 2 illustrates an example of data relocation when a node is added. A case will be discussed where a new node N4 is added to the distributed data store after data D is stored in the node N3. Note that the magnitude relation among the function values f_1(k), f_2(k), and f_3(k) for the respective nodes N1 to N3 does not change even when the node N4 is added.

Thus, the least function value among the function values f_1(k) to f_4(k) as a result of the calculation of the function value f_4(k) for the new node N4 varies as in patterns PATTERN_1 and PATTERN_2. In PATTERN_1, the function value f_3(k) for the node N3 is still the least. In PATTERN_2, the function value f_4(k) for the node N4 is the least.

In PATTERN_1, data D is not relocated. On the other hand, in PATTERN_2, the node N4 is determined as the node N for storing the data D, and the data D stored in the node N3 is relocated to the node N4. In other words, when the node N4 is added, the data D is not relocated unless the function value f_4(k) for the node N4 is the least. Thus, the occurrence of data relocation between nodes may be suppressed.

Example of Data Relocation When Node is Deleted

FIG. 3 illustrates an example of data relocation when a node is deleted. Respective cases in PATTERN_3 and PATTERN_4 will be discussed. PATTERN_3 is the case where the node N3 within a distributed data store is deleted after data D is stored in the node N3. PATTERN_4 is the case where the node N2 is deleted after data D is stored in the node N3.

In PATTERN_3, because the node N3 is deleted, the data D stored in the node N3 is relocated. However, even when the node N3 is deleted, the magnitude relation between the function values f_1(k) and f_2(k) for the remaining respective nodes N1 and N2 does not change. Thus, the data D stored in the node N3 is relocated to the node N1 having the next least function value to that for the node N3. On the other hand, in PATTERN_4, the data D is not relocated. In other words, when a node is deleted, the data D is not relocated unless the node N3 which stores the data D is deleted. Therefore, the occurrence of data relocation between nodes may be suppressed.

Example of Distributed System

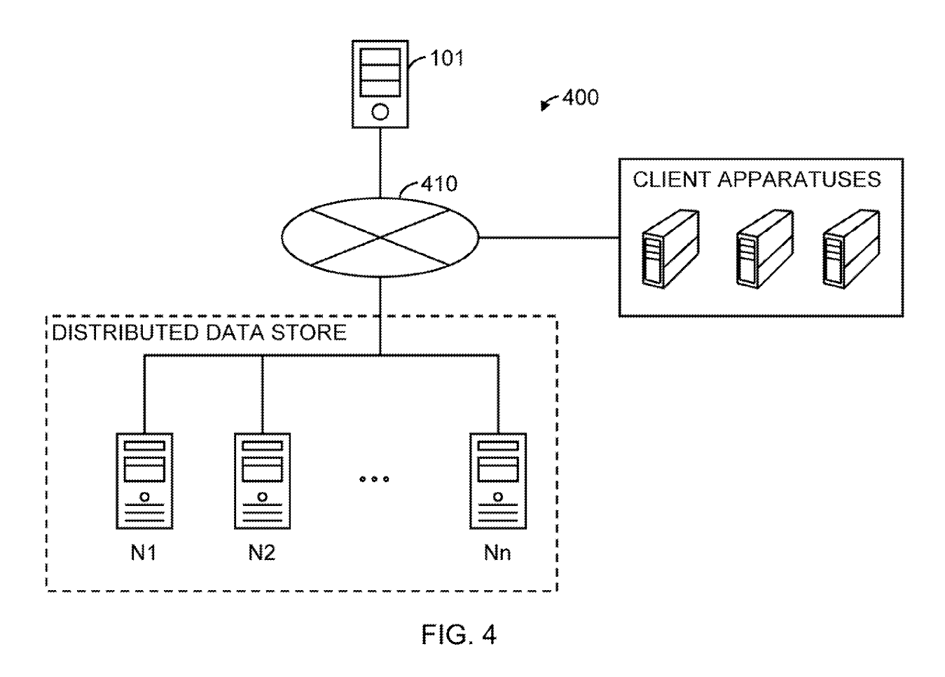

FIG. 4 illustrates an example of a distributed system according to the present embodiment. Referring to FIG. 4, a distributed system 400 includes a node determination apparatus 101, nodes N1 to Nn, and client apparatuses. In the distributed system 400, the node determination apparatus 101, the nodes N1 to Nn and the client apparatuses may be communicably connected with each other through a network 410 such as the Internet, a local area network (LAN), and a wide area network (WAN).

Each of the nodes N1 to Nn may be a server such as a file server and a database server. The client apparatus may be a computer which receives a service from a data store, for example. The client apparatus is allowed to refer to data D stored in a node N within a distributed data store by using a key k for the data D.

In the following discussion, an arbitrary node N among a plurality of nodes N1 to Nn will be referred to as a node Ni (where i=1, 2, . . . , n). A data group to be stored will be referred to as data D1 to Dm, an arbitrary data piece D among the data D1 to Dm will be referred to as data Dj (where j=1, 2, . . . , m). The key for uniquely identifying the data Dj will be referred to as a key kj.

Hardware Configuration of Computer

A hardware configuration of a computer (the node determination apparatus 101, the nodes N1 to Nn, the client apparatus) used in the present embodiment will be discussed.

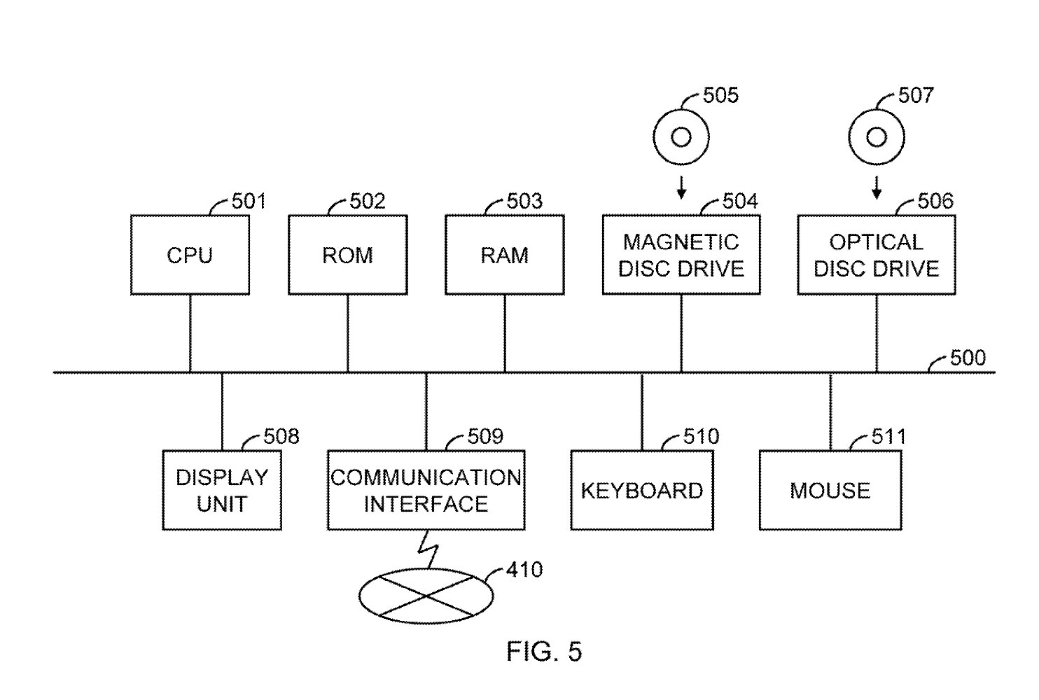

FIG. 5 illustrates an exemplary hardware configuration of a computer. Referring to FIG. 5, the computer includes a central processing unit (CPU) 501, a read-only memory (ROM) 502, a random access memory (RAM) 503, a magnetic disc drive 504 for driving a magnetic disc 505, an optical disc drive 506 for driving an optical disc 507, a display unit 508, a communication interface 509, a keyboard 510, and a mouse 511. These components are connected via a bus 500.

The CPU 501 is responsible for control over the entire computer. The ROM 502 stores a program such as a boot program. The RAM 503 is used as a work area of the CPU 501. The magnetic disc drive 504 controls data read/write on the magnetic disc 505 under the control of the CPU 501. The magnetic disc 505 stores the data written under the control of the magnetic disc drive 504.

The optical disc drive 506 controls data read/write on the optical disc 507 under the control of the CPU 501. The optical disc 507 may store the data written under the control of the optical disc drive 506 and/or causes a computer to read the data stored in the optical disc 507.

The display unit 508 displays data such as a document, an image and function information, including a cursor, an icon and/or a toolbox. The display unit 508 may be a cathode-ray tube (CRT), thin-film transistor (TFT) liquid crystal display, a plasma display or the like.

The communication interface 509 is connected to the network 410 such as an LAN, a WAN, and the Internet through a communication line and is connected to another apparatus through the network 410. The communication interface 509 is responsible for an internal interface of the computer to/from the network 410 and controls the input/output of data from/to an external device. The communication interface 509 may be a modem, an LAN adapter or the like, for example.

The keyboard 510 has keys for inputting letters, numbers and/or an instruction and may be used for inputting data. The keyboard 510 may be a touch panel input pad, a numeric keypad, or the like. The mouse 511 may be used to move a cursor, select a range, move a window, change a size and so on. The mouse 511 may be replaced with a trackball, a joystick or the like as far as it has similar functions as a pointing device.

Functional Configuration of Node Determination Apparatus

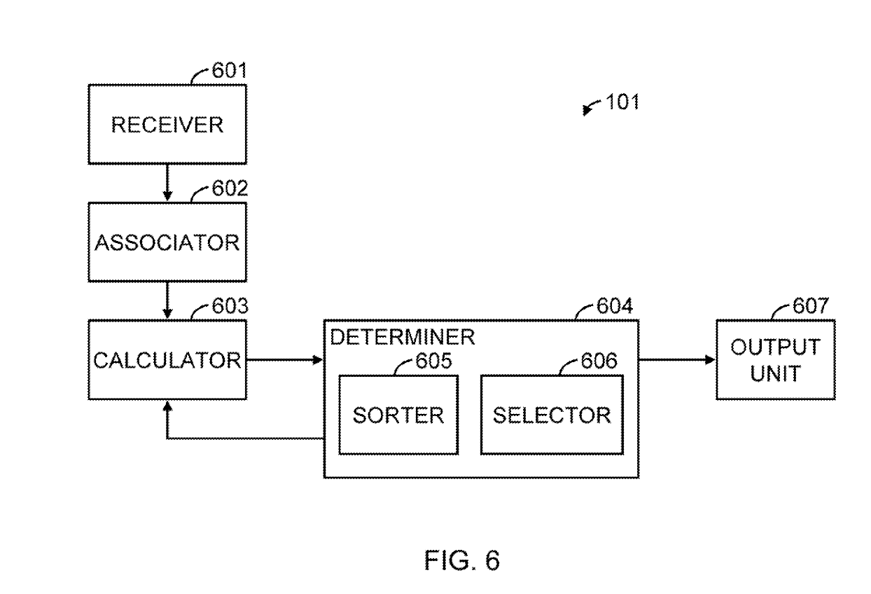

A functional configuration of the node determination apparatus 101 according to the present embodiment will be discussed. FIG. 6 illustrates an exemplary functional configuration of the node determination apparatus 101. Referring to FIG. 6, the node determination apparatus 101 includes a receiver 601, an associator 602, a calculator 603, a determiner 604, and an output unit 607. The determiner 604 includes a sorter 605 and a selector 606. The function units (receiver 601 to output unit 607) may be implemented by, for example, causing the CPU 501 to execute a program stored in a storage device such as the ROM 502, RAM 503, magnetic disc 505, and optical disc 507 illustrated in FIG. 5 or through the communication interface 509. The processing results of the function units (receiver 601 to output unit 607) are stored in a storage device such as the RAM 503, magnetic disc 505, and optical disc 507 unless otherwise indicated.

The receiver 601 receives key information regarding data Dj to be stored. The key information may contain a data name (such as Dj) of the data to be stored, a key kj, and a redundancy Rj, for example. The data Dj may be an information unit in the form of a folder, a file, or a record, for example. The key kj may be a character string such as a path name of a file or a main key of a record within a database, for example. The redundancy Rj refers to the number of nodes when the data Dj with the identical key kj is stored in a plurality of nodes Ni redundantly from a viewpoint of fault tolerance.

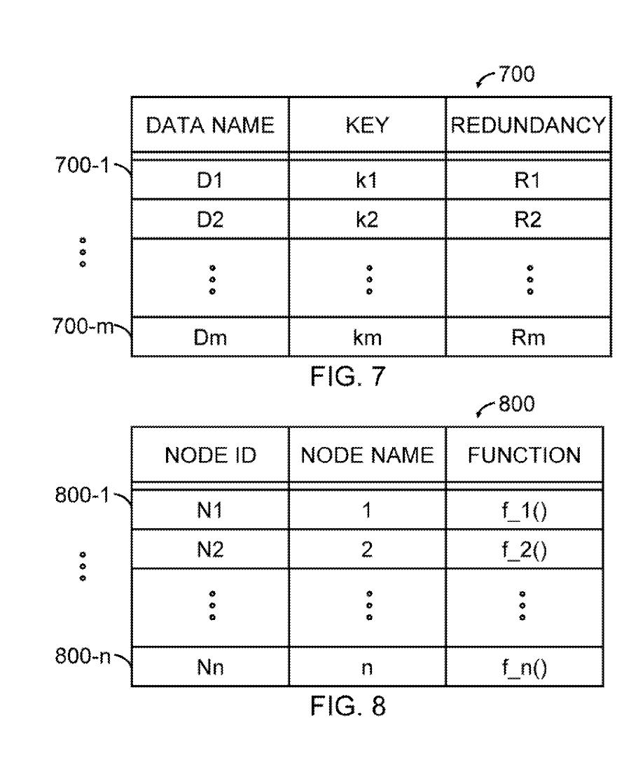

Specifically, the receiver 601 receives key information upon a user performing an input operation through the keyboard 510 and/or mouse 511 illustrated in FIG. 5. The receiver 601 may receive key information from a client apparatus over the network 410. The received key information may be stored in a key list 700 illustrated in FIG. 7, for example.

FIG. 7 illustrates an exemplary data structure of the key list 700. The key list 700 has key information records (record 700-1 to record 700-m in FIG. 7). Each key information record includes a “data name” field, a “key” field and a “redundancy” field. The “data name” field stores a name (such as Dj) of the data. The “key” field stores a key which is information for uniquely identifying the data Dj. The “redundancy” field stores the number of nodes when the data Dj is stored in a plurality of nodes Ni redundantly.

The stored information stored in the key list 700 may be updated every time key information is received or data Dj is deleted from the distributed data store, for example. The key list 700 may be stored in a storage device such as the ROM 502, RAM 503, magnetic disc 505, and optical disc 507, for example.

Referring back to FIG. 6, the receiver 601 receives a node determination instruction in response to an increase or decrease of the number of nodes within the distributed data store. The node determination instruction refers to an instruction to determine again the node Ni for storing the data Dj in response to the increase or decrease of the number of nodes.

Specifically, a node determination instruction in response to node addition contains a node name (such as i) of the node to be added to the distributed data store, for example. The addition of a new node Ni may be performed for the purpose of improvement of performance of the distributed system 400, for example. A node determination instruction in response to node deletion may contain a node name (such as i) of the node to be deleted from the distributed data store, for example. The deletion of a node Ni may be performed when the node Ni fails, for example.

For example, the receiver 601 may receive a node determination instruction as a result of an input operation by a user through the keyboard 510 and/or mouse 511. The receiver 601 may receive a node determination instruction from a node Ni or client apparatus through the network 410.

The associator 602 may associate a function with each node Ni. Hereinafter, a function for a node Ni will be referred to as a function f_i( ) The function f_i( ) is different for each node Ni. Its domain contains a key kj for the data Dj, and its range defines magnitude relation among function values. In other words, the function f_i( ) has its domain containing the range of the values that the key kj may take. With the ranges of the functions, the magnitude relation among function values may be determined.

Specifically, for example, the associator 602 selects an arbitrary function as the function f_i( ) from a function group F prepared in advance and associates the node Ni with the function f_i( ) The association result may be stored in a function list 800 illustrated in FIG. 8, for example. The function group F is a set of functions, the number of which is at least the number of nodes n. Information regarding the function group F is stored in a storage device such as the ROM 502, RAM 503, magnetic disc 505 and optical disc 507.

Alternatively, the associator 602 may prepare one function f( ) which may take two arguments and define the function f_i( ) as in Expression (1). In this case, i is a node name of a node Ni, and kj is a key for data Dj. Information regarding the function f( ) taking two arguments may be stored in a storage device such as the ROM 502, RAM 503, magnetic disc 505, and optical disc 507.

f_i( )==f(i,kj) (1)

The function f_i( ) may be an arbitrary function as far as it satisfies the aforementioned conditions for the domain and range. Specifically, for example, the function f_i( ) may be a function which may provide a fixed-length random number when a key is given as an argument. More specifically, for example, the function f_i( ) may be a hash function such as a secure hash algorithm 1 (sha1). The sha1 is a function which provides largely different outputs for slightly different inputs. For example, when the key kj and node name i are both integers, the function f_i( ) may be a function “f_i( )=kj+i” which adds the node name i to the key kj.

The functions f_1( ) to f_n( ) of the respective nodes N1 to Nn may be mutually independent functions having function values whose frequency distributions are sufficiently equal. Specifically, for example, the associator 602 may use a hash function such as a sha1 to define the function f_i( ) as the following Expression (2). In this case, the concatenate(i,kj) is a function which concatenates the node name i of a node Ni and the key kj for the data Dj as a character string.

f_i( )==sha1(concatenate(i,kj)) (2)

FIG. 8 illustrates an exemplary data structure of the function list 800. The function list 800 has function information records (record 800-1 to record 800-n in FIG. 8). Each function information record includes a “node identifier (ID)” field, a “node name” field and a “function” field.

The “node ID” field stores an identifier (such as Ni) of a node, which is given for convenience of discussion herein. The “node name” field stores a name (such as i) of the node. The “function” field stores information indicating a function f_i( ) which is associated with the node Ni. The function list 800 may be stored in a storage device such as the ROM 502, RAM 503, magnetic disc 505, and optical disc 507, for example.

Referring back to FIG. 6, the calculator 603 inputs the key kj into the function f_i( ) for each of the associated nodes Ni to calculate the value (hereinafter, referred to as a function value f_i(kj)) of the function f_i( ) for the node Ni. Specifically, for example, the calculator 603 gives the key k as an argument to the function f_i( ) to calculate the function value f_i(k) for each of the nodes Ni.

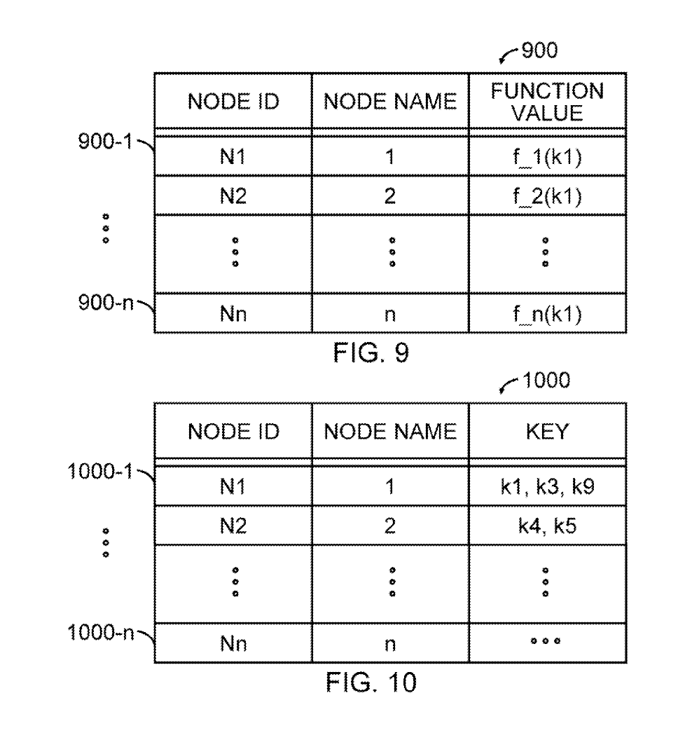

When the Expression (1) is used as the function f_i( ) the calculator 603 gives the node name i of a node Ni and the key kj as arguments to Expression (1) to calculate the function value f_i(kj) for the node Ni. The calculation result may be stored in a function value list 900 illustrated in FIG. 9, for example.

FIG. 9 illustrates an exemplary data structure of the function value list 900. The function value list 900 has function value information records (record 900-1 to record 900-n in FIG. 9). Each function value information record includes a “node ID” field, a “node name” field and a “function value” field. The “node ID” field stores an identifier (such as Ni) of a node. The “node name” field stores a name (such as i) of the node. The “function value” field stores a function value f_i(kj) of a function f_i( ) which is associated with the node Ni. The function value list 900 may be stored in a storage device such as the ROM 502, RAM 503, magnetic disc 505, and optical disc 507, for example.

Referring back to FIG. 6, the determiner 604 determines a node Ni for storing data Dj on the basis of the magnitude relation among calculated function values f_i(kj) of the nodes Ni. Specifically, for example, the determiner 604 determines, for storing the data Dj, the node Ni corresponding to the least (or biggest) function value f_i(kj) among the function values f_1(kj) to f_n(kj) for the node N.

The sorter 605 sorts the function values f_i(kj) for the respective nodes Ni on the basis of the magnitude relation among the calculated function values f_i(kj) of the nodes Ni. Specifically, for example, the sorter 605 sorts the function values f_1(kj) to f_n(kj) for the respective nodes N1 to Nn in ascending order (or descending order).

The selector 606 selects a predetermined number of nodes Ni from the nodes N1 to Nn in accordance with the order of the sorted function values f_i(kj) for the respective nodes Ni. Here, the predetermined number may be a redundancy Rj for the data Dj, for example. In the following discussions, the sorted function values f_1(kj) to f_n(kj) for the respective nodes N1 to Nn will be expressed by function values f[1] to f[n].

Specifically, for example, the selector 606 first selects Rj function values f[1] to f[Rj] from the beginning (or end) of the sorted function values f[1] to f[n]. The selector 606 identifies and selects Rj nodes corresponding to the selected function values f[1] to f[Rj] with reference to the function value list 900.

In the following discussions, the selected Rj nodes will be expressed by nodes N[1] to N[Rj]. When the redundancy Rj is equal to “1” (Rj=1), the selector 606 may select a node Ni after a predetermined number of nodes from the beginning (or end) of the sorted function values f[1] to f[n].

The determiner 604 may determine the selected predetermined number of nodes Ni as the nodes N for storing the data Dj. Specifically, for example, the determiner 604 determines the selected Rj nodes N[1] to N[Rj] as the nodes N for storing the data Dj. The determination result is stored in a node/key correspondence list 1000 illustrated in FIG. 10.

FIG. 10 illustrates an exemplary data structure of the node/key correspondence list 1000. The node/key correspondence list 1000 has node/key correspondence records (record 1000-1 to record 1000-n in FIG. 10). Each node/key correspondence record includes a “node ID” field, a “node name” field and a “key” field. The “node ID” field stores an identifier (such as Ni) of a node. The “node name” field stores a name (such as i) of the node. The “key” field stores keys.

For example, when the node N1 is determined as the node N for storing data D1, D3 and D9, the keys k1, k3, and k9 for the respective data D1, D3 and D9 are stored in the “key” field of the record 1000-1. When the node N2 is determined as the node N for storing the data D4 and D5, the keys k4 and k5 of the respective data D4 and D5 are stored in the “key” field of the record 1000-2. The key kj for data Dj may be identified with reference to the key list 700, for example.

Referring back to FIG. 6, the output unit 607 outputs a determination result. Specifically, for example, the output unit 607 may output the node/key correspondence list 1000 illustrated in FIG. 10. The output may be display on the display unit 508, print output to a printer (not illustrated) or transmission to an external device through the communication interface 509, for example. Alternatively, the node/key correspondence list 1000 may be stored in a storage area such as the RAM 503, magnetic disc 505, and optical disc 507.

More specifically, for example, the output unit 607 may transmit the node/key correspondence list 1000 to an external computer which controls data relocation between nodes. In this case, for example, the external computer controls data relocation between nodes in accordance with the node/key correspondence list 1000. Alternatively, the output unit 607 may transmit an instruction to relocate data Dj to a node Ni in accordance with the node/key correspondence list 1000.

Having discussed the case where the node determination apparatus 101 and a node Ni are provided separately, the present embodiment is not limited thereto. More specifically, for example, a node Ni may include the node determination apparatus 101.

Node Determination Management Performed by Node Determination Apparatus

Node determination management performed by the node determination apparatus 101 according to the present embodiment will be discussed. Here, a case will be discussed where a node N for storing data D1 to Dm is determined among the nodes N1 to Nn.

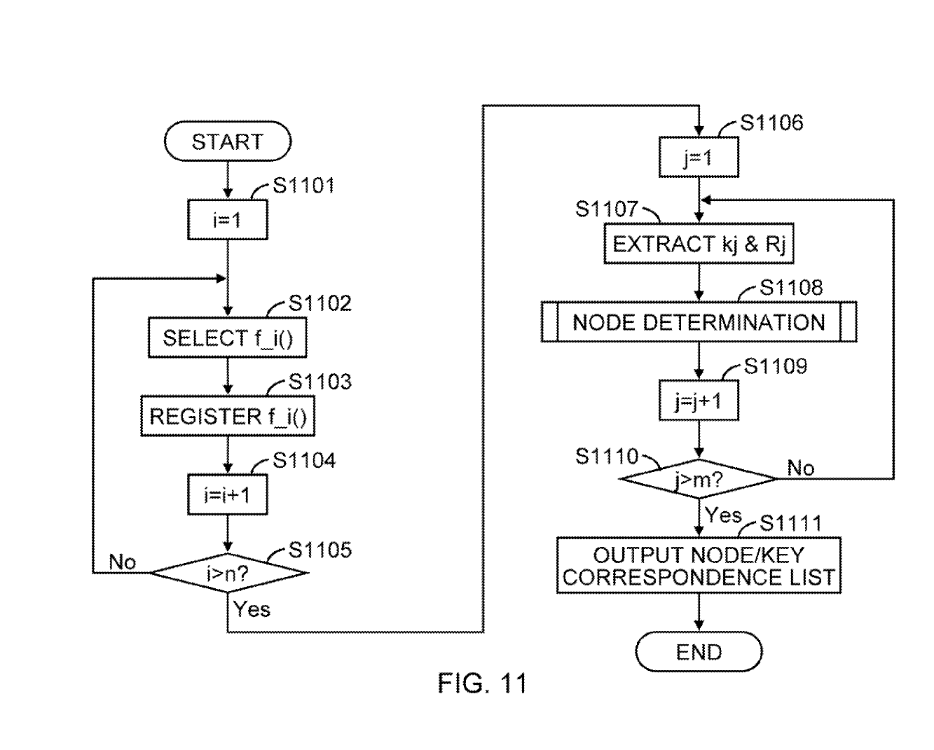

FIG. 11 illustrates an exemplary operation flow of node determination management performed by the node determination apparatus 101.

In S1101, the associator 602 first initializes i of the node Ni as “i=1”.

In S1102, the associator 602 selects a function Li( ) from the function group F.

In S1103, the associator 602 associates the node name of the node Ni with the selected function f_i( ) and registers them with the function list 800.

In S1104, the associator 602 increments i of the node Ni.

In S1105, the associator 602 determines whether i is larger than n or not. When i is not larger than n (“No” in S1105), the node determination apparatus 101 returns the process to S1102.

In S1106, when i is larger than n (“Yes” in S1105), the calculator 603 initializes j of the data Dj as “j=1”.

In S1107, the calculator 603 extracts the key kj and redundancy Rj for the data Dj from the key list 700.

In S1108, the determiner 604 performs node determination process of determining the nodes N for storing the data Dj.

In S1109, the calculator 603 increments j of the data Dj.

In S1110, the calculator 603 determines whether j is larger than m or not. When j is not larger than m (“No” in S1110), the node determination apparatus 101 returns the process to S1107.

In S1111, when j is larger than m (“Yes” in S1110), the output unit 607 outputs the node/key correspondence list 1000. Thereafter, the node determination apparatus 101 terminates the process.

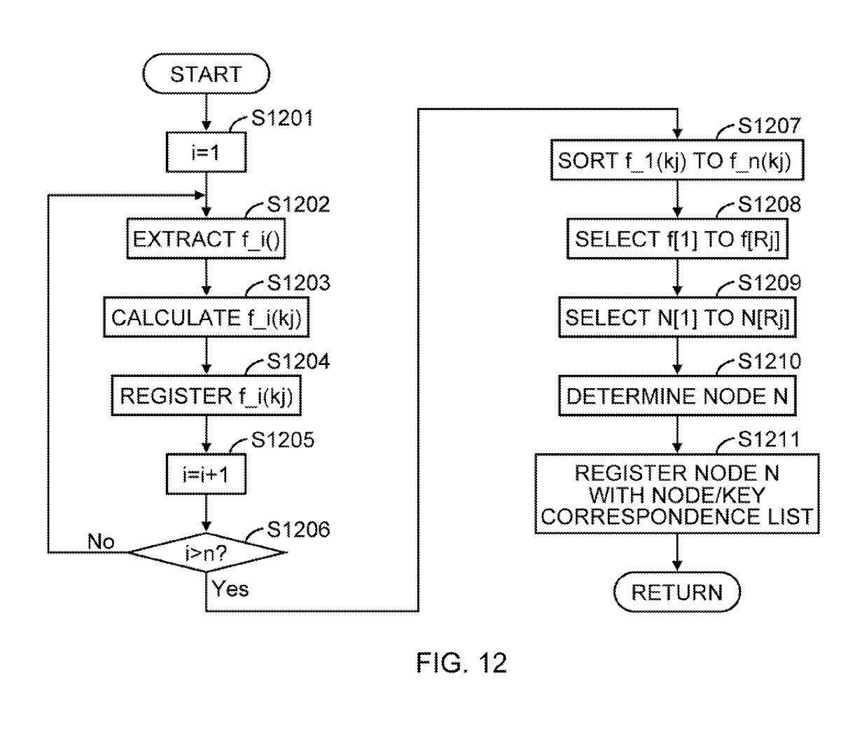

Next, the node determination process of S1108 illustrated in FIG. 11 will be discussed in detail. FIG. 12 illustrates an exemplary operation flow of a node determination process performed by the node determination apparatus 101.

In S1201, the calculator 603 first initializes i of the node Ni as “i=1”.

In S1202, the calculator 603 extracts the function f_i( ) for the node Ni from the function list 800.

In S1203, the calculator 603 inputs the key kj extracted in S1107 illustrated in FIG. 11 into the extracted function f_i( ) to calculate the function value f_i(kj) for the node Ni.

In S1204, the calculator 603 registers the calculated function value f_i(kj) for the node Ni with the function value list 900.

In S1205, the calculator 603 increments i of the node Ni.

In S1206, the calculator 603 determines whether i is larger than n or not.

When i not larger than n (“No” in S1206), the node determination apparatus 101 returns the process to S1202.

In S1207, when i is larger than n (“Yes” in S1206), the sorter 605 refers to the function value list 900 to sort the function values f_1(kj) to f_n(kj) in ascending order.

In S1208, the selector 606 then selects Rj function values f[1] to f[Rj] from the beginning of the sorted function values f[1] to f[n]. In this case, Rj is the redundancy Rj extracted in S1107 illustrated in FIG. 11.

In S1209, the selector 606 then refers to the function value list 900 to select the nodes N[1] to N[Rj] corresponding to the selected Rj function values f[1] to f[Rj].

In S1210, the determiner 604 determines the selected nodes N[1] to N[Rj] as the nodes N for storing the data Dj.

In S1211, the determiner 604 registers the determination result with the node/key correspondence list 1000. Thereafter, the node determination apparatus 101 returns the process to S1109 illustrated in FIG. 11.

Thus, the node N for storing the data Dj may be determined on the basis of the magnitude relation among the function values f_i(k) acquired by giving the key kj as an argument to the function f_i( ) for a node Ni. This may result in reduction of the frequency of occurrence of data relocation between nodes when the number of nodes within a distributed data store increases or decreases.

Node Determination Management Performed When Node is Added

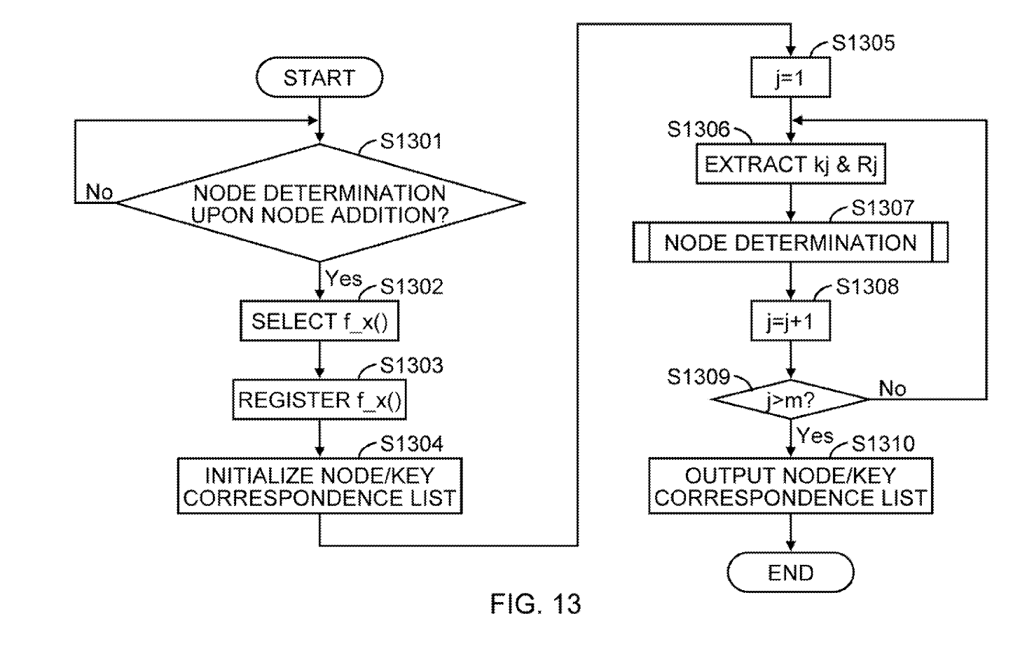

Node determination management performed by the node determination apparatus 101 when a node is added will be discussed. Hereinafter, the node to be added newly to a distributed data store will be referred to as a node Nx. FIG. 13 illustrates an exemplary operation flow of node determination management performed by the node determination apparatus 101 when a node is added.

In S1301, the receiver 601 first determines whether a node determination instruction in response to node addition has been received or not. When the node determination instruction in response to node addition has not been received (“No” in S1301), the node determination apparatus 101 returns the process to S1301.

In S1302, when the node determination instruction in response to node addition has been received (“Yes” in S1301), the associator 602 selects a function f_x( ) for the node Nx from the function group F.

In S1303, the associator 602 associates the node name of the node Nx with the selected function f_x( ) and registers them with the function list 800. In this case, the node name and function f_x( ) for the node Nx are registered as the record 800-n at the end of the function list 800.

In S1304, the determiner 604 initializes the node/key correspondence list 1000.

In S1305, the calculator 603 then initializes j of the data Dj as “j=1”.

In S1306, the calculator 603 extracts the key kj and redundancy Rj for the data Dj from the key list 700.

In S1307, the determiner 604 performs node determination process of determining the nodes N for storing the data Dj.

In S1308, the calculator 603 increments j of the data Dj.

In S1309, the calculator 603 determines whether j is larger than m or not.

When j is not larger than m (“No” in S1309), the node determination apparatus 101 returns the process to S1306.

In S1310, when j is larger than m (“Yes” in S1309), the output unit 607 outputs the node/key correspondence list 1000. Thereafter, the node determination apparatus 101 terminates the process.

Thus, the nodes N for storing the data D1 to Dm may be determined again when a node is added to the distributed data store. When data relocation occurs in response to the addition of a node Nx, the data Dj is relocated to the newly added node Nx. Thus, the performance in node addition may be efficiently improved. Since the specific operation flow of the node determination process in S1307 is similar to the specific operation flow of the node determination process in S1108, which is illustrated in FIG. 12, the discussion will be omitted.

Node Determination Management Performed When Node is Deleted

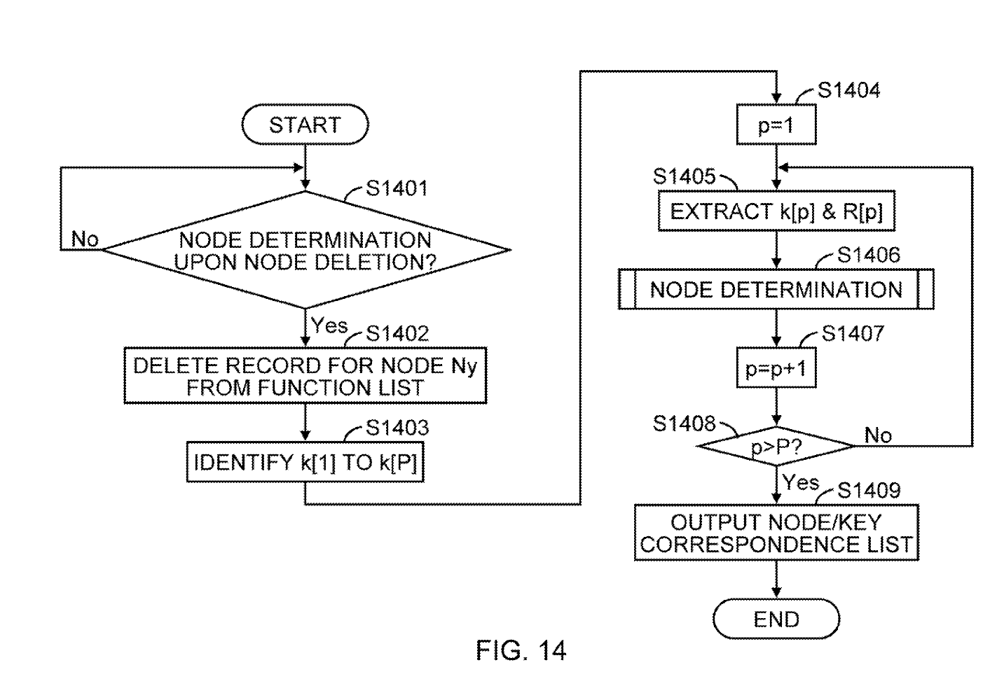

Node determination management performed by the node determination apparatus 101 when a node is deleted will be discussed. The node to be deleted from a distributed data store will be referred to as node Ny. FIG. 14 illustrates an exemplary operation flow of node determination management performed by the node determination apparatus 101 when a node is deleted.

In S1401, the receiver 601 first determines whether a node determination instruction in response to node deletion has been received or not. When the node determination instruction in response to node deletion has not been received (“No” in S1401), the node determination apparatus 101 returns the process to S1401.

In S1402, when the node determination instruction in response to node deletion has been received (“Yes” in S1401), the associator 602 deletes the record corresponding to the node Ny from the function list 800. New node IDs within the function list 800 are given after the record corresponding to the node Ny is deleted.

In S1403, the determiner 604 next identifies keys (expressed by k[1] to k[P] here) corresponding to the node Ny with reference to the node/key correspondence list 1000.

In S1404, the calculator 603 then initializes p of the data Dp as “p=1”.

In S1405, the calculator 603 extracts the key k[p] and redundancy R[p] for the data Dp from the key list 700.

In S1406, the determiner 604 performs node determination process of determining the nodes N for storing the data Dp.

In S1407, the calculator 603 increments p of the data Dp.

In S1408, the calculator 603 determines whether p is larger than P or not.

When p is not large than P (“No” in S1408), the node determination apparatus 101 returns the process to S1405.

In S1409, when p is larger than P (“Yes” in S1408), the output unit 607 outputs the node/key correspondence list 1000. Thereafter, the node determination apparatus 101 terminates the process.

Thus, when a node is deleted from the distributed data store, nodes N for storing data D[1] to D[P] currently stored in the node Ny to be deleted may be determined again. Since the specific operation flow of the node determination process in S1406 is similar to the specific operation flow of the node determination process in S1108, which is illustrated in FIG. 12, the discussion will be omitted.

Concrete Example of Node Determination Process

A concrete example of node determination process performed by the node determination apparatus 101 will be discussed. Hereinafter, the function f_i( ) for the node Ni is Expression (3) below. In this case, i is the node name of the node Ni, kj is a key for data Dj, and (i+kj) is a concatenated character string of the node name and the key.

f_i( )==f(i,kj)==<the first 32 bits of sha1(i+kj)> (3)

(i) If n=5:

First, there will be discussed a case where nodes N for storing data D1 to D20 is determined among the nodes N1 to N5, assuming that the number of nodes n within a distributed data store is 5 (n=5). In this case, the node names of the respective nodes N1 to N5 are “n00”, “n01”, “n02”, “n03”, and “n04”.

It is assumed that the redundancies R1 to R20 for the respective data D1 to D20 are all “2”. The node determination apparatus 101 determines the nodes N corresponding to the first and second function values from the beginning of the function values for the respective nodes N1 to N5 sorted in ascending order for storing the data Dj identified with the key kj. In the following discussions, the 32 bits of the result (function value) of the function f_i(kj) is expressed in hexadecimal.

When the key k1 for the data D1 is “k00”, the function values for the respective nodes N1 to N5 calculated by using the Expression (3) and sorted in ascending order by the node determination apparatus 101 are as follows:

f_n01(“k00”)=0e2ec04a

f_n04(“k00”)=115aaafa

f_n02(“k00”)=326d28c9

f_n03(“k00”)=54895176

f_n00(“k00”)=85a25d67

In this case, the node N having the least function value among the nodes N1 to N5 is the node N2 (node name: n01), and the node N having the next least function value is the node N5 (node name: n04). Thus, the nodes N2 and N5 are used for storing the data D1 identified with the key k1 (“k00”).

When the key k2 for the data D2 is “k01”, the function values for the respective nodes N1 to N5 calculated by using the Expression (3) and sorted in ascending order by the node determination apparatus 101 are as follows:

f_n01(“k01”)=ac5a52a0

f_n03(“k01”)=b623b072

f_n00(“k01”)=d3008e9c

f_n02(“k01”)=e0c43847

f_n04(“k01”)=e1ebf581

In this case, the node N having the least function value among the nodes N1 to N5 is the node N2 (node name: n01), and the node N having the next least function value is the node N4 (node name: n03). Thus, the nodes N2 and N4 are used for storing the data D2 identified with the key k2 (“k01”).

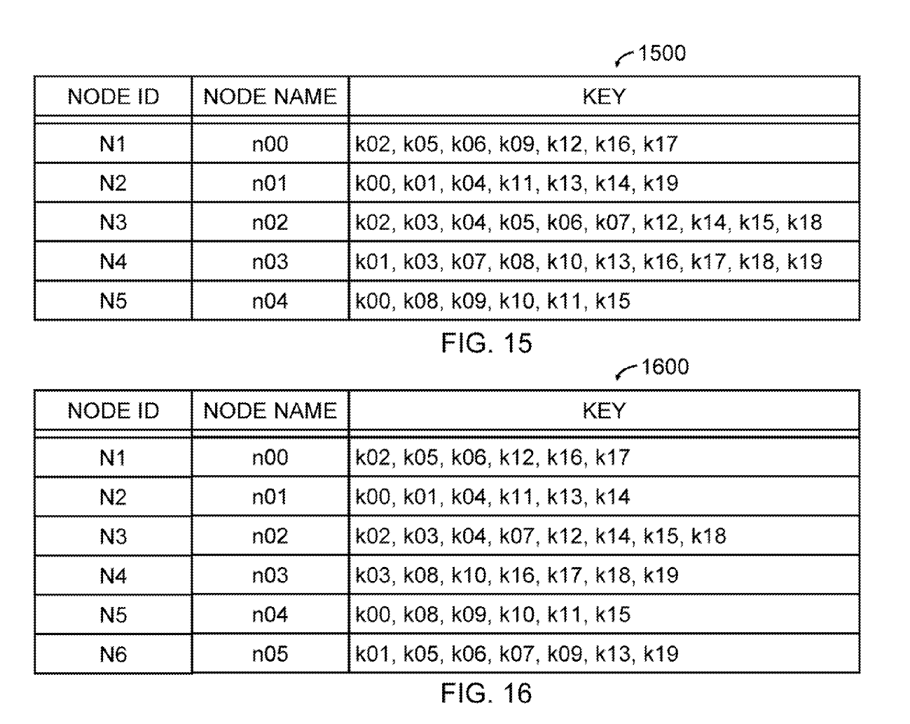

In the same manner, when the keys k3 to k20 for the data D3 to D20 are “k02” to “k19”, determining the nodes for storing the data D3 to D20 results in correspondence relation between node names and keys in a node/key correspondence list 1500 illustrated in FIG. 15.

FIG. 15 illustrates a concrete example of information stored in the node/key correspondence list 1500. Specifically, FIG. 15 illustrates correspondence relation between a node name and keys for each of the nodes N1 to N5. It may be said that the data D1 to D20 are distributed sufficiently evenly when the number of keys associated with the respective nodes N1 to N5 is close to “K×R/n”. In this case, K is the total number of keys kj, R is a redundancy for data Dj, and n is the number of nodes.

Here, since “K=20, R=2, and n=5”, it may be said the data D1 to D20 are distributed sufficiently evenly when the number of keys associated with the nodes N1 to N5 is close to “8”. In the example illustrated in FIG. 15, seven keys are associated with the node N1, the seven keys with the node N2, ten keys with the node N3, ten keys with the node N4, and six keys with the node N5. Thus, the data D1 to D20 with a redundancy of 2 are distributed sufficiently evenly.

(ii) If n=6:

Next, there will be discussed a case where the number of nodes n within the distributed data store increases from 5 (n=5) to 6 (n=6). Here, the node name of the newly added node N6 is “n05”.

In the same manner, when the key k1 for the data D1 is “k00”, the function values for the respective nodes N1 to N6 calculated by using the Expression (3) and sorted in ascending order by the node determination apparatus 101 are as follows:

f_n01(“k00”)=0e2ecO4a

f_n04(“k00”)=115aaafa

f_n02(“k00”)=326d28c9

f_n03(“k00”)=54895176

f_n05(“k00”)=5633a21a

f_n00(“k00”)=85a25d67

Similarly to the case where the number of nodes n is equal to 5 (n=5), the node N having the least function value among the nodes N1 to N6 is the node N2 (node name: n01), and the node N having the next least function value is the node N5 (node name: n04). Thus, the nodes for storing the data D1 identified with the key k1 (“k00”) are not changed.

When the key k2 for the data D2 is “k01”, the function values for the respective nodes N1 to N6 calculated by using the Expression (3) and sorted in ascending order by the node determination apparatus 101 are as follows:

f_n05(“k01”)=58262a5c

f_n01(“k01”)=ac5a52a0

f_n03(“k01”)=b623b072

f_n00(“k01”)=d3008e9c

f_n02(“k01”)=e0c43847

f_n04(“k01”)=e1ebf581

In this case, the node N having the least function value among the nodes N1 to N6 is the node N6 (node name: n05), and the node N having the next least function value is the node N2 (node name: n01). Thus, the nodes for storing the data D2 identified with the key k2 (“k01”) are changed from the nodes N2 and N4 to the nodes N6 and N2.

In the same manner, when the keys k3 to k20 for the data D3 to D20 are “k02” to “k19”, determining the nodes for storing the data D3 to D20 results in correspondence relation between node names and keys in a node/key correspondence list 1600 illustrated in FIG. 16.

FIG. 16 illustrates a concrete example of information stored in the node/key correspondence list 1600. Specifically, FIG. 16 illustrates correspondence relation between a node name and keys for each of the nodes N1 to N6. It may be said that the amount of data relocation upon changing the number of nodes is close to a minimum when the total number of data Dj (or the total number of keys kj) to be relocated upon changing the number of nodes is sufficiently close to “K×R×1/(n+1)”.

Since “K=20, R=2, and n=5”, it may be said that the amount of data relocation is close to a minimum when the number of keys for the data to be relocated is close to “7”. In the example illustrated in FIG. 16, as a result of the addition of the node N6, the nodes for storing the data D2, D6, D7, D8, D10, D14, and D20 identified with the keys “k01”, “k05”, “k06”, “k07”, “k09”, “k13”, and “k19” are changed. Thus, the amount of data relocation upon changing the number of nodes is sufficiently close to a minimum.

As discussed above, the node determination apparatus 101 according to the present embodiment may prepare different functions f_i( ) for nodes Ni and determine the node N for storing the data Dj on the basis of the magnitude relation among the function values f_i(k) acquired by inputting the key kj for the data Dj as an argument. After this, even when the number of nodes increases or decreases, the magnitude relation among the function values f_i(k) for the original nodes does not change. Thus, the data Dj is not relocated between nodes excluding a node to be added or deleted.

The node determination apparatus 101 may determine a predetermined number of nodes N for storing the data Dj in accordance with the order of the function values f_i(k) for the respective nodes Ni sorted on the basis of the magnitude relation. Thus, even when the number of nodes increases or decreases, the magnitude relation among the function values f_i(k) for the original nodes does not change when the data Dj is stored into Rj nodes Ni redundantly. Therefore, the data Dj is not relocated between nodes excluding a node to be added or deleted.

The node determination apparatus 101 may use a pair of a node name and function f_i( ) for a node Ni to determine the node N for storing the data Dj. Thus, the amount of information for determining a node for storing the data Dj may be reduced, compared with a method for determining a node N for storing the data Dj by managing the node N for storing the data Dj for each key kj. When a function f( ) taking two arguments as in the Expression (1) is used, the node N for storing the data Dj may be determined by using the function f( ) and the node name of each node Ni. Therefore, the amount of information may further be reduced.

The node determination apparatus 101 may use mutually independent functions f_1( ) to f_n( ) having function values whose frequency distribution is sufficiently equal so that the data D1 to Dm may be distributed into the nodes N1 to Nn evenly. Specifically, the probability that an arbitrary function value f_i(kj) is the least (or biggest) among the function values f_1(kj) to f_n(kj) is “1/n”. Similarly, the probability that an arbitrary function value f_i(kj) is the ith least (or biggest) is “1/n”. Thus, the nodes for storing the data Dj may be determined evenly, and the data D1 to Dm may be distributed into the nodes N1 to Nn sufficiently evenly.

The node determination apparatus 101 may use mutually independent functions f_1( ) to f_n( ) having function values whose frequency distribution is sufficiently equal so that various combinations of a plurality of nodes Ni may be provided when the data Dj is redundantly stored. Specifically, the probability that the function value f_y(kj) is the second least (or biggest) is “1/(n−1)” for the key kj with which the function value f_x(kj) is the least (or biggest) among the function values f_1(kj) to f_n(kj). Thus, when the data Dj is stored into a plurality of nodes Ni redundantly, the nodes for storing the data Dj may be determined evenly, providing various combinations of a plurality of nodes Ni. Therefore, for example, when the data Dj is stored into the nodes N1 to N3 redundantly, the condition that a fault in the node N1 always imposes loads on the nodes N2 and N3 may be avoided.

The node determination method according to the embodiments may be implemented by causing a computer such as a personal computer and a workstation to execute a node determination program prepared in advance. The node determination program may be recorded in a computer-readable recording medium such as a hard disc, a flexible disc, a compact disc ROM (CD-ROM), a magneto-optical disc (MO), and a digital versatile disc (DVD) and may be read by a computer from the recording medium. The node determination program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been discussed in detail, it should be understood that the various changes, substitutions, and alterations could be made hereto without departing from the spirit and scope of the invention.

What is claimed is:

1. A non-transitory computer-readable medium storing a node determination program causing a computer to execute a node determination method, the node determination method comprising:
associating a function with each of a plurality of nodes;
calculating, by inputting a key for identifying specific data to each of the functions, a function value of the each of the functions;
determining, on the basis of magnitude relation of the calculated function values, nodes for storing the specific data; and
outputting a result of the determination.

2. The non-transitory computer-readable medium according to claim 1, the node determination method further comprising:
sorting the calculated function values in accordance with the magnitude relation;
selecting a predetermined number of nodes from the plurality of nodes in accordance of an order of the sorted function values,
wherein
the computer determines the selected nodes as the nodes for storing the specific data.

3. The non-transitory computer-readable medium according to claim 1, wherein
when a new node is added to the plurality of nodes, the computer executes the associating, the calculating, and the determining for each of data stored in the plurality of nodes.

4. The non-transitory computer-readable medium according to claim 1, wherein
when a node is deleted from the plurality of nodes, the computer executes the associating, the calculating, and the determining for each of data stored in the deleted node.

5. The non-transitory computer-readable medium according to claim 1, wherein
the function value of the each of the functions is a fixed-length random number.

6. A node determination apparatus, comprising:
an associator configured to associate a function with each of a plurality of nodes;
a calculator configured to calculate, by inputting a key for identifying specific data to each of the functions, a function value of the each of the functions;
a determiner configures to determine, on the basis of magnitude relation of the calculated function values, nodes for storing the specific data; and
an output unit configured to output a result of the determination.

7. A node determination method executed by a computer for determining a node for storing specific data, the node determination method comprising:
associating, by the computer, a function with each of a plurality of nodes;
calculating, by inputting a key for identifying the specific data to each of the functions, a function value of the each of the functions;
determining, on the basis of magnitude relation of the calculated function values, nodes for storing the specific data; and
outputting a result of the determination.
